(19) United States
(12) Patent Application Publication
(10) Pub. No.: US 2004/0236789 A1
(43) Pub. Date: Nov. 25, 2004

(54) Techniques for creation and execution of print jobs

(76) Inventors: Yasuhiko Uchida, Nagano-ken (JP); Hiroyasu Tamagawa, Nagano-ken (JP); Satoru Momose, Nagano-ken (JP); Kazunori Shimoda, Nagono-ken (JP)

Correspondence Address: MARTINE & PENILLA, LLP, 710 LAKEWAY DRIVE, SUITE 170, SUNNYVALE, CA, 94085, US

(21) Appl. No.: 10/723,165

(22) Filed: Nov. 26, 2003

(30) Foreign Application Priority Data
Mar. 12, 2003 (JP) 2003-066822

(51) Int. Cl. G06F 7/00

(52) U.S. Cl. 707/104.1

(57) ABSTRACT

A default printer and a paper type are set for each combination of a print service and a paper size in a tabular form. The setting field has a printer setting box 67 on the upper row to set a default printer used for execution of a print job and a paper type setting box 68 on the lower row to set a selected type of printing paper. A pulldown menu is open in the printer setting box 67 to allow the user to select a desired printer among printers connecting with a local network and printers connecting with another network different from the local network. In response to an execution instruction of a selected print job, in which a printer connecting with the different network is set to the default printer, the selected print job is sent to an apparatus, in which a driver of the default printer is installed. The apparatus executes the selected print job.

### BACKGROUND OF THE INVENTION

1. Field of the Invention

The present invention relates to techniques for creation and execution of print jobs. More specifically the invention pertains to a print job creation apparatus that creates a print job and gives an instruction of executing the created print job, a default device setting method that sets a default printing device for execution of a print job in a computer, and a print execution instruction method that creates a print job and gives an instruction of executing the created print job.

2. Description of the Prior Art

Proposed print job creation apparatuses function to read picture images taken with a digital camera, introduce simple modifications of the images, incorporate the images in a layout, such as a postcard or an album, and set printing conditions. These prior art apparatuses read photographs, classify the photographs into desired categories to be stored like films, and create print jobs. The print job creation process includes a film selection step, a print service selection step of selecting a desired print service, for example, postcard printing, album printing, or calendar printing, a photograph selection step of selecting photographs to be printed, a print setting step of specifying settings of a style, a print option, and a printer, a layout adjustment step of adjusting a layout of pages with photographs incorporated therein, and a print step of finely adjusting the printing position, inputting the number of copies, and giving a print execution instruction. At the print setting step, a conventionally used printer for a certain OS (operating system) is set to a default printer in a printer selection box, and the user may change the default printer to another printer selected in a pulldown menu (see ‘Digital Camera de!! Doji Print (Simultaneous Printing with Digital Camera) 6, User'sManual, 1^{st} ed. A. I. Soft. Inc., July 2002, p 100-104).

Such prior art print job creation apparatuses are mainly designed for general household use and accordingly have only a low printing efficiency in business use. In general household use, only one printer, which is capable of printing to a size A4 or a size B4, is typically connected to a computer and is used for printing. The printer is thus naturally set to the default printer. In business use, however, multiple printers having different printable paper sizes and various paper types are generally used for printing. Selection of a suitable printer for each print job undesirably lowers the printing efficiency.

### SUMMARY OF THE INVENTION

The print job creation apparatus and the print execution instruction method of the present invention aim to ensure execution of a print job by a printing device suitable for the print job. The print job creation apparatus and the print execution instruction method of the invention aim to execute a print job by a printing device connecting with a different local network as a default printing device. The print job creation apparatus, the print execution instruction method, and the default device setting method of the invention aim to easily set a printing device suitabe for a print job to a default printing device. The print job creation apparatus, the print execution instruction method, and the default device setting method of the invention aim to set a printing device connecting with a different local network to a default printing device.

In order to achieve at least a part of the aforementioned objects, the print job creation apparatus, the print execution instruction method, and the default device setting method of the invention are constructed as follows.

A first print job creation apparatus of the invention creates a print job and gives an instruction of executing the created print job, and the print job creation apparatus includes: a print job creation module that creates a print job according to a predetermined process of multiple steps, which include a step of setting printing conditions including a paper size; a default device setting module that selects a printing device for execution of a print job among multiple printing devices connected via a network and setting the selected printing device to a default printing device for each paper size specified in a print job; and a job execution instruction module that receives an execution request of a selected print job, and gives a print job execution instruction to cause the default printing device set by the default device setting module to execute the selected print job, based on a paper size specified in the selected print job.

In response to an execution request of a selected print job, the first print job creation apparatus of the invention gives a print job execution instruction to execute the selected print job by the printing device, which is selected among the multiple printing devices connected via the network and is set to the default printing device for the paper size specified in the selected print job. This arrangement enables the print job to be executed by the printing device set to the default printing device without independently setting the printing device for execution of the print job. The default printing device is set for each paper size. The print job is thus executed by the printing device suitable for the print job.

In the first print job creation apparatus of the invention, as one aspect, the default device setting module may set a printing device connecting with the local network, to which the print job creation apparatus is connected, as the default printing device. In addition, the default device setting module may specify a printer driver of a printing device to set the default printing device.

In the first print job creation apparatus of the invention, as another aspect, the print job creation apparatus may further include: a job transmission module that sends a print job to another print job creation apparatus connected to the network; and a job fetch module that fetches a print job via the network.

A second print job creation apparatus of the invention creates a print job and gives an instruction of executing the created print job, and the print job creation apparatus includes: a print job creation module that creates a print job according to predetermined process of multiple steps, which include a step of setting printing conditions including a paper size; a default device setting module that selects a printing device used for execution of a print job, among multiple printing devices including at least one first local printing device connected via a first local network and at least one second local printing device connected via a second local network, which is linked with the first local network via a global network, and sets the selected printing device to a default printing device for each paper size specified in a print job; and a job execution instruction module that receives an execution request of a selected print job, and gives a print job execution instruction to cause the default printing device set by the default device setting module to execute the selected print job, based on a paper size specified in the selected print job.

In response to an execution request of a selected print job, the second print job creation apparatus of the invention gives a print job execution instruction to execute the selected print job by the printing device that is selected among the first local printing devices connecting with the first local network and the second local printing devices connecting with the second local network, which is linked with the first local network via the global network, and is set to the default printing device for the paper size specified in the selected print job. This arrangement enables the print job to be executed by the first local printing device or the second local printing device set to the default printing device without independently setting the printing device for execution of the print job. The default printing device is set for each paper size. The print job is thus executed by the printing device suitable for the print job.

In the second print job creation apparatus of the invention, as one aspect, a print execution instruction device, which gives a print job execution instruction to the second local printing device, may be connected to the second local network, and the job execution instruction module may output the selected print job, which is to be transmitted to the print execution instruction device, when the second local printing device is set to the default printing device for execution of the selected print job by the default device setting module. In this case, the job execution instruction module may output execution request information regarding the execution request of the selected print job, together with the selected print job, which is to be transmitted to the print execution instruction device and the job execution instruction module may send the selected print job, which is to be transmitted to the print execution instruction device, to a print management server that is connected with the global network and is capable of delivering the selected print job to the print execution instruction device. The default device setting module may use execution-related information regarding execution of a print job by the first local printing device when the first local printing device is set to the default printing device, while using apparatus-related information regarding the second local printing device and the print execution instruction device when the second local printing device is set to the default printing device. In this case, the default device setting module may use a printer driver of the first local printing device as the execution-related information, when the first local printing device is set to the default printing device.

In the second print job creation apparatus of the invention, as another aspect, the print job creation apparatus may further include a job fetch module that fetches a print job via the first local network, and job execution instruction module may give a print job execution instruction to execute the fetched print job. In this case, the job fetch module may fetch the print job via the global network.

In the first and second print job creation apparatus of the invention, the default device setting module may set the default printing device for each paper size in a tabular form. The default device setting module may select the default printing device for each paper size out of a list of printing device options for the paper size. The default device setting module may specify a paper type, which is used in the default printing device set for each paper size.

In the first and second print job creation apparatus of the invention, the print job creation module may select one print service among multiple print services to create the print job, and the default device setting module may set a default printing device for each print service. In this case, the multiple print services may include at least one of an enlargement printing service, a digest printing service, a calendar printing service, a postcard printing service, a photo name card printing service, an ID photograph printing service, a seal printing service, a label printing service, and an album printing service.

In the first and second print job creation apparatus of the invention, the print job creation apparatus may further include an execution device setting module that specifies a printing device for execution of a print job, and the job execution instruction module may give the print job execution instruction, when the execution device setting module specifies a printing device for execution of a selected print job, to cause the specified printing device to execute the selected print job, and when the execution device setting module does not specify any printing device for execution of the selected print job, give the print job execution instruction to cause the default printing device set by the default device setting module to execute the selected print job. In this case, the execution device setting module may set a printing device, which is set corresponding to a paper size specified in the selected print job by the default device setting module, to a default and change the setting of the default to specify a printing device for execution of the print job.

The present invention is not restricted to the first print job creation apparatus or to the second print job creation apparatus discussed above. The technique of the invention may also be actualized by a method of setting a default printing device, which is adopted in the first print job creation apparatus or in the second print job creation apparatus, as well as a method of setting a default printing device and giving an execution instruction of a print job, which is adopted in the first print job creation apparatus or in the second print job creation apparatus.

### BRIEF DESCRIPTION OF THE DRAWINGS

FIG. 1 schematically illustrates the configuration of a print job management system 10;

FIG. 2 shows the schematic construction of a print job creation apparatus 20;

FIG. 3 shows the schematic construction of a job management apparatus 40;

FIG. 4 shows an example of menu window 60;

FIG. 5 shows an example of environment settings selection window 65;

FIG. 6 shows an example of printer settings window 66;

FIG. 7 shows a pulldown menu open in a printer setting box 67;

FIG. 8 shows a pulldown menu open in a paper type setting box 68;

FIG. 9 is a flowchart showing a print job creation routine;

FIG. 10 shows an example of image registration window 70;

FIG. 11 shows an example of template selection window 80;

FIG. 12 shows an example of layout editing window 90;

FIG. 13 shows an example of print window 100;

FIG. 14 is a flowchart showing a print instruction routine;

FIG. 15 shows an example of management of print jobs;

FIG. 16 shows the data structure of a job file as an example;

FIG. 17 is a flowchart showing a job reception management routine;

FIG. 18 shows the data structure of job management data as an example;

FIG. 19 is a flowchart showing a job transmission management routine;

FIG. 20 is a flowchart showing a job reception routine; and

FIG. 21 shows an example of management of print jobs.

### DESCRIPTION OF THE PREFERRED EMBODIMENTS

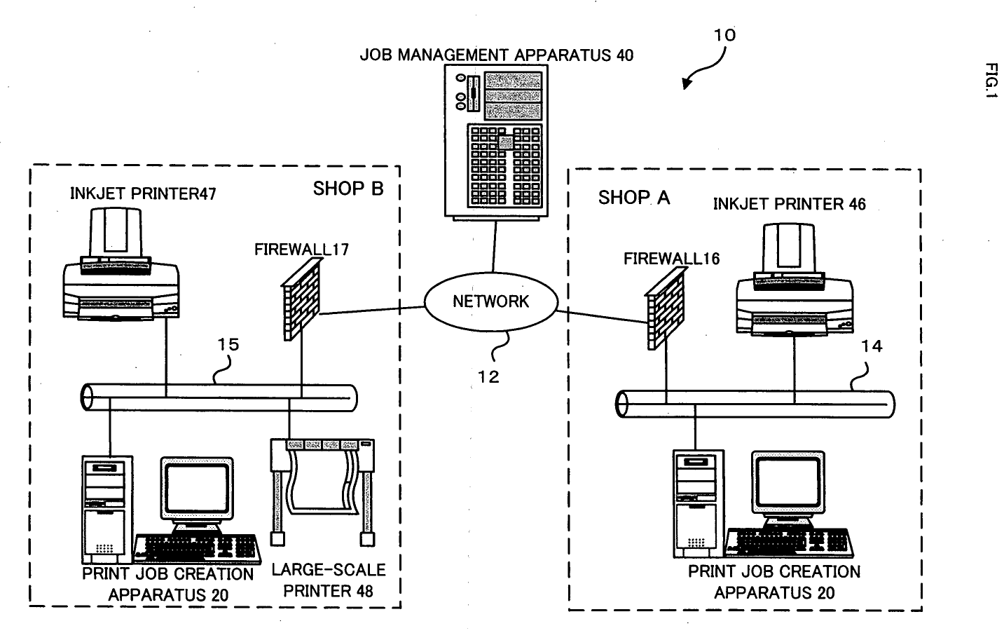

A preferred embodiment of the invention is discussed below. FIG. 1 schematically illustrates the configuration of a print job management system 10 including a print job creation apparatus 20 in one embodiment of the invention. In the illustrated print job management system 10 of the embodiment, a local network 14 connecting with the print job creation apparatus 20 and an inkjet printer 46 and a local network 15 connecting with the print job creation apparatus 20, an inkjet printer 47, and a large-scale printer 48 are respectively connected to a global network 12, such as the Internet, via firewalls 16 and 17. A job management apparatus 40 is also connected to the network 12. For simplicity of explanation, it is assumed that the local network 14 is constructed in a shop A and that the local network 15 is constructed in a shop B. Namely the print job creation apparatus 20 and the inkjet printer 46 are connected to the local network 14 at the shop A, while the print job creation apparatus 20, the inkjet printer 47, and the large-scale printer 48 are connected to the local network 15 at the shop B.

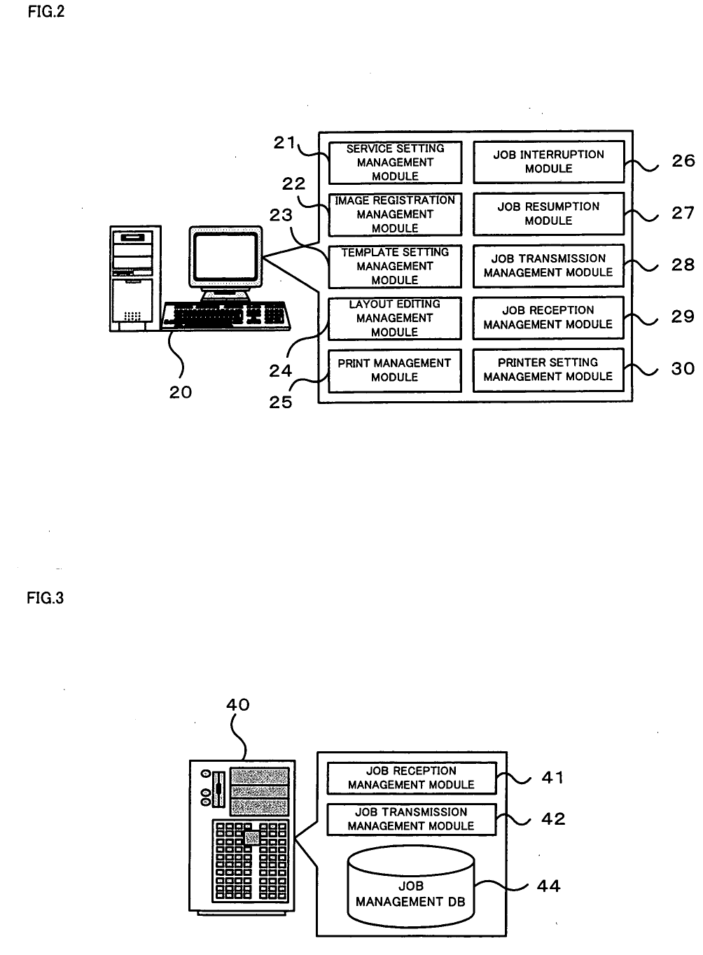

FIG. 2 shows the schematic construction of the print job creation apparatus 20 of the embodiment. The print job creation apparatus 20 of the embodiment is constructed as a general computer, in which a non-illustrated print job creation program as application software and support data including template images used for printing are installed. Execution of the print job creation program causes the computer to function as the print job creation apparatus. The print job creation apparatus 20 of the embodiment creates print jobs as various print services including creation of calendars and creation of postcards and gives instructions of executing such print jobs. As shown in FIG. 2, the print job creation apparatus 20 has, as its functional blocks, a service setting management module 21 that accepts settings for creation of each print job from each of various print services, an image registration management module 22 that manages registration of images used for each print job, a template setting management module 23 that manages settings of templates used for each print job, a layout editing management module 24 that manages adjustment of a layout of images and editing of images, and a print management module 25 that manages settings of printing and printing instructions. The print job creation apparatus 20 also includes a job interruption module 26 that interrupts creation of a print job in the middle, a job resumption module 27 that resumes creation of a print job, which has been interrupted in the middle of its creation (hereafter referred to as print job under creation), a job transmission management module 28 that manages transmission of each print job in response to a print execution instruction, a job reception management module 29 that manages reception of each print job sent from the job management apparatus 40 as an object to be printed, and a printer setting management module 30 that manages settings of each printer. The print job creation device 20 of the embodiment further includes a job input output management module that functions to send and receive each print job under creation to and from another print job creation apparatus 20 and a job duplication module that duplicates a print job under creation or an executed print job to start creation of a new print job, although these modules are not specifically illustrated. As matter of convenience, only one print job creation apparatus 20 is connected to each of the local networks 14 and 15 in the illustration of FIG. 1. In the actual state, however, multiple print job creation apparatuses 20 may be connected to each of the local networks 14 and 15.

Each of the inkjet printers 46 and 47 is capable of high-quality color printing to a size A4, whereas the large-scale printer 48 is capable of high-quality color printing to a size Al. As matter of convenience, only one inkjet printer 46 is connected to the local network 14 and only one inkjet printer 47 and one large-scale printer 48 are connected to the local network 15 in the illustration of FIG. 1. In the actual state, however, a plurality of identical or different printers may be connected to each of the local networks 14 and 15.

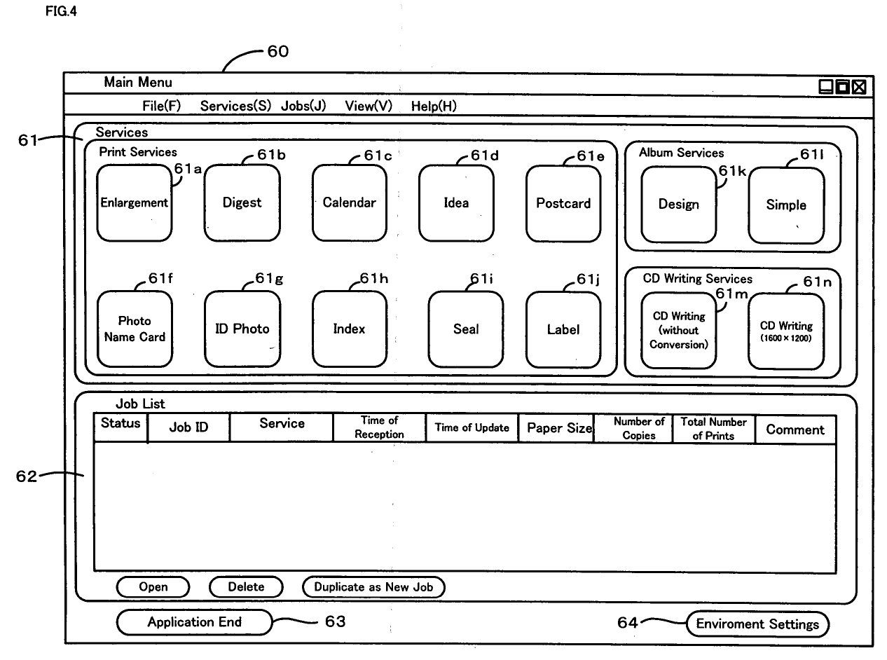

FIG. 3 shows the schematic construction of the job management apparatus 40. The job management apparatus 40 is constructed as a management server that receives a file of each print job sent from each of the print job creation apparatuses 20 as an object to be printed and sends the file of the print job to another print job creation apparatus 20 specified as a transmission destination of the file. As illustrated, the job management apparatus 40 includes a job reception management module 41 that manages reception of a job file sent from each of the print job creation apparatuses 20, a job transmission management module 42 that manages transmission of each job file to a print job creation apparatus 20 specified as a transmission destination of the job file, and a job management database 44 that is used for management of reception of job files by the job reception management module 41 and for management of transmission of job files by the job transmission management module 42.

The following describes the operations of the print job creation apparatus 20 and the job management apparatus 40 of the embodiment constructed as discussed above. The description mainly regards the operations of the print job creation apparatus 20, in combination with the operations of the job management apparatus 40 according to the requirements.

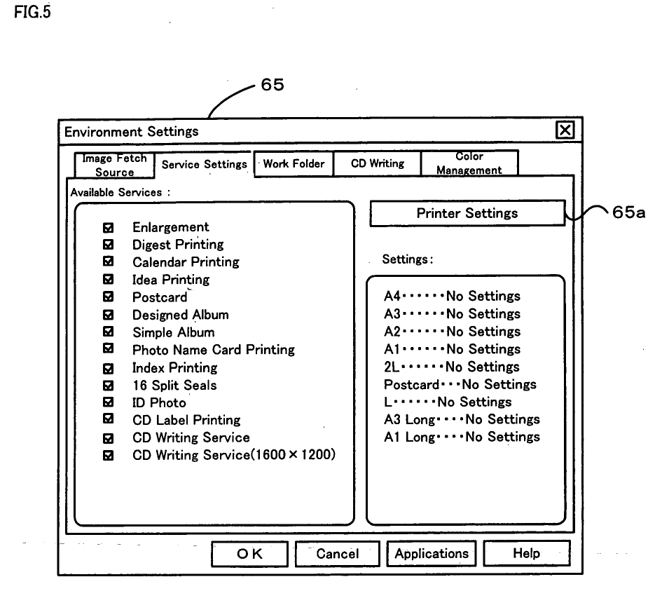

FIG. 4 shows an example of menu window 60 open on the display of the print job creation apparatus 20 on startup of the non-illustrated print job creation program as the application software. The menu window 60 of FIG. 4 has a service selection field 61 for selecting a desired print service and a job list field 62 for displaying a list of print jobs. The service selection field 61 includes various selection buttons for print services, album services, and CD writing services. The buttons for print services include an ‘Enlargement’ button 61a to print an image in a large size, a ‘Digest’ button 61b to print multiple images as a digest, a ‘Calendar’ button 61c to print a calendar with images, an ‘Idea’ button 61d to print an image with any of templates of various designs, a ‘Postcard’ button 61e to print an image on a postcard, a ‘Photo Name Card’ button 61f to print name cards with a photograph, an ‘ID Photo’ button 61g to print an ID photograph, an ‘Index’ button 61h to print an index of a large number of images, a ‘Seal’ button 61i to create seals with an image, and a ‘Label’ button 61j to create labels for CDs and DVDs. The buttons for album services include a ‘Design’ button 61k to create an album with any of templates of various designs and a ‘Simple’ button 611 to create an album with a simple template. The buttons for CD writing services include a ‘CD Writing (without Conversion)’ button 61m to write an image into a CD without any conversion and a ‘CD Writing (1600×1200)’ button 61n to alter the size of an image to 1600×1200 and write the image of the altered size into a CD. The status, the job ID, the selected service, the time of reception, the time of update, the paper size, the number of copies, the total number of prints, and the comment with regard to respective print jobs under creation are listed in the job list field 62. The menu window 60 also has an ‘Application End’ button 63 and an ‘Environment Settings’ button 64 for settings of an image fetch source, services, a work folder, CD writing, and color management, which are both located below the job list field 62.

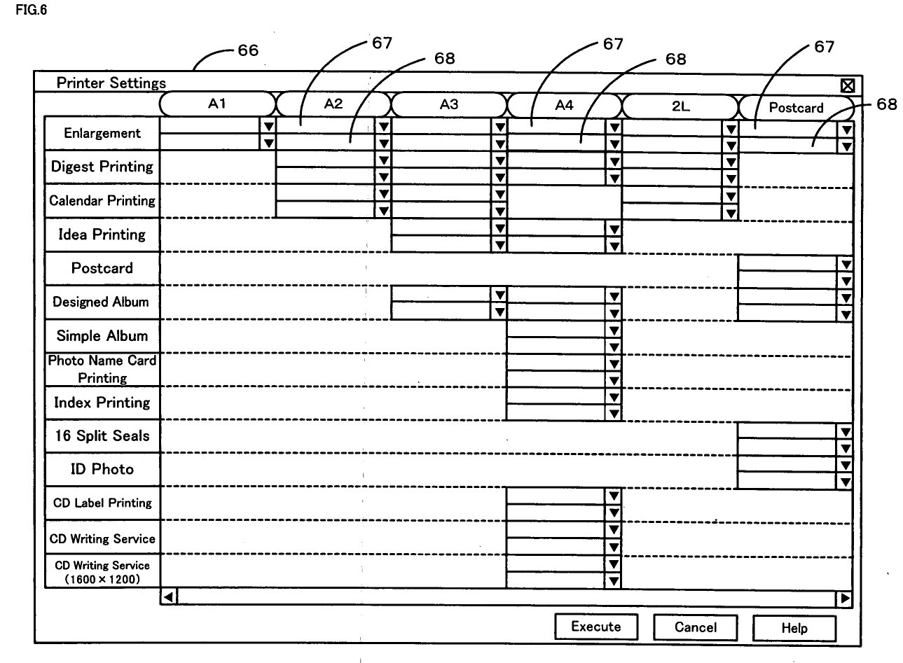

FIG. 5 shows an example of environment settings selection window 65 open in response to a click of the ‘Environment Settings’ button 64. In the illustrated example of FIG. 5, a service settings dialog box is open. A click of a ‘Printer Settings’ button 65a in this service settings dialog box opens a printer settings window 66 for default settings of printers. An example of the printer settings window 66 is shown in FIG. 6. The printer settings window 66 of the embodiment displays a list of available services against printable paper sizes in a tabular form. A default printer is settable for each combination of a print service and a paper size. Each setting field includes a printer setting box 67 on the upper row to set a selected printer used for printing and a paper type setting box 68 on the lower row to set a selected type of printing paper. Desired entries are respectively selected in the setting boxes 67 and 68 among available printers and among available paper types displayed in the form of pulldown menus 67a and 68b.

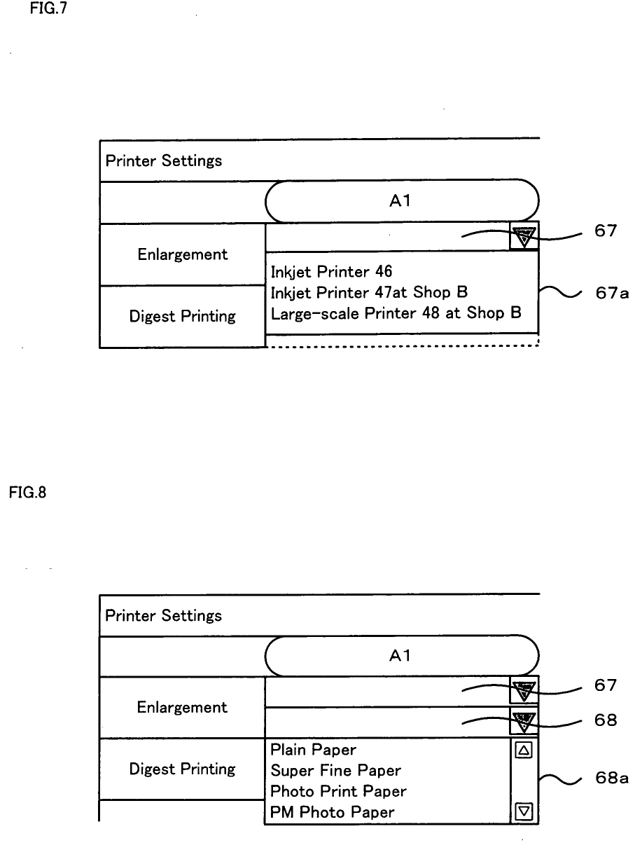

FIG. 7 shows an example of the pulldown menu 67a open for the printer setting box 67 by the print job creation apparatus 20 at the shop A. In this illustrated example, the pulldown menu 67a of the printer setting box 67 shows available printers, that is, the ink-jet printer 46 connected to the local network 14 at the shop A and the inkjet printer 47 and the large-scale printer 48 at the shop B. The user selects a desired printer as a default printer in the pulldown menu 67a of the printer setting box 67 allocated to each combination of the print service and the paper size. When the printer (the ink-jet printer 46) connected to the local network 14 is selected and set as a default printer, the procedure sets a printer driver name to use a printer driver for printing, which is installed in the print job creation apparatus 20 to make the selected printer usable by the print job creation apparatus 20. When the printer (the inkjet printer 47 or the large-scale printer 48) connected to the local network 15 is selected and set as a default printer, on the other hand, the procedure sets an apparatus ID of the selected print job creation apparatus 20, in which a printer driver of the selected printer is installed, among the print job creation apparatuses 20 connected to the local network 15, and a printer ID allocated to the selected printer. The available printers displayed in the pulldown menu 67a and their settings may be provided in the form of a table by each of the print job creation apparatuses 20. The table may alternatively be distributed from the job management apparatus 40 to each of the print job creation apparatuses 20.

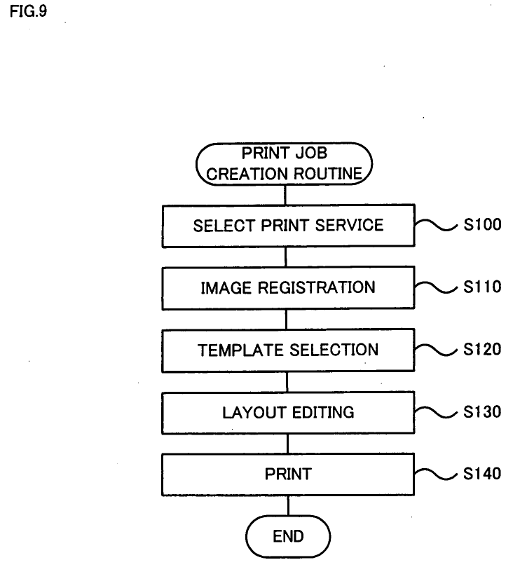

FIG. 8 shows an example of the pulldown menu 68a open for the paper type setting box 68 by the print job creation apparatus 20 at the shop A. In this illustrated example, the pulldown menu 68a of the paper type setting box 68 shows available paper types including plain paper, super file paper, and photo print paper. The user selects a desired paper type as a default paper type in the pulldown menu 68a of the paper type setting box 68 allocated to each combination of the print service and the paper size. The printer setting management module 30 executes and manages these settings of the default printer and the default paper type.

The print job creation apparatus 20 of the embodiment creates a print job according to a print job creation routine shown in FIG. 9. The print job creation routine first receives selection of a desired print service (step S100). The user clicks one of the available service buttons 61a through 61n in the service selection field 61 of the menu window 60 shown in FIG. 4 to select a desired print service. The service setting management module 21 of the print job creation apparatus 20 manages display of the menu window 60, acceptance of selection of a service, and start of creation of a print job in the selected service.

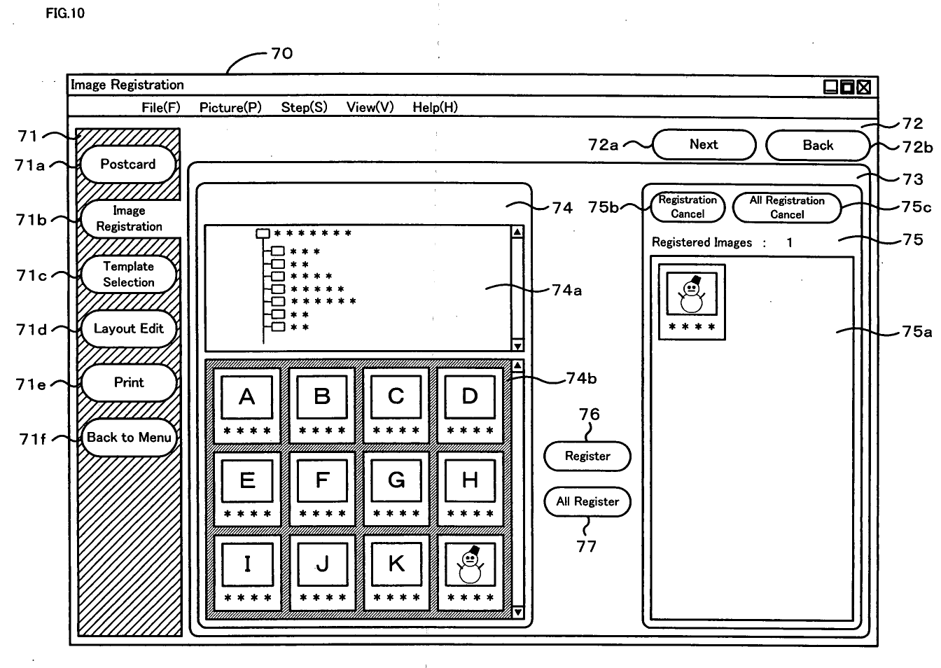

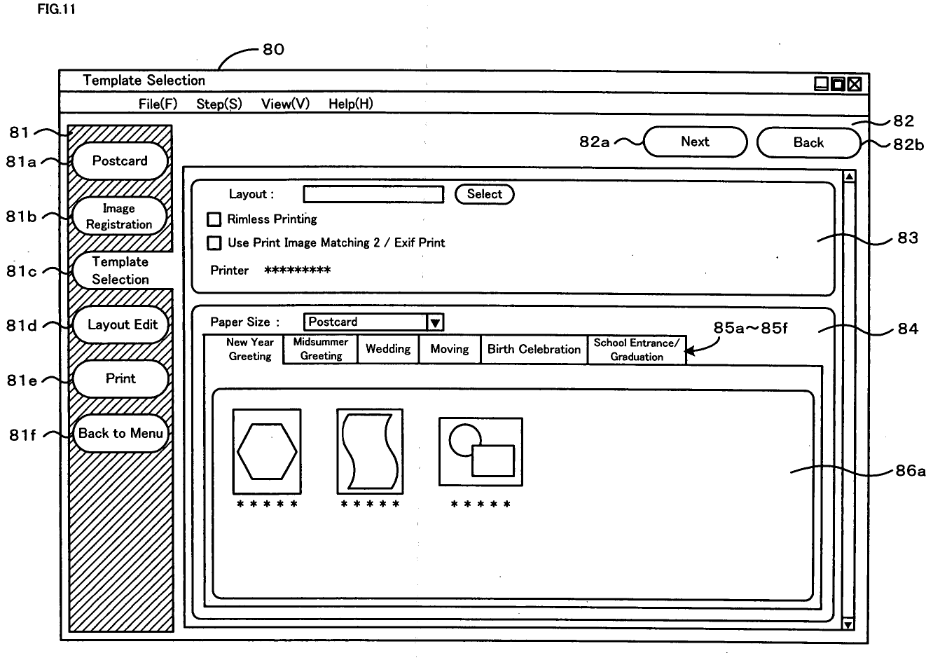

In response to selection of a desired print service, the print job creation apparatus 20 of the embodiment opens an image registration window 70 shown in FIG. 10 and executes an image registration step to register images used for the selected print service (step S110). In the illustrated example of FIG. 10, the image registration window 70 has a process display field 71 to display a print job creation process and an image registration dialog box 72 to register selected images. The process display field 71 includes a ‘Selected Service Display’ button 71a to display a selected print service, an ‘Image Registration’ button 71b, a ‘Template Selection’ button 71c, a ‘Layout Edit’ button 71d, and a ‘Print’ button 71e showing steps in the print job creation process, and a ‘Back to Menu’ button 71f to interrupt creation of a current print job and go back to the menu window 60. The image registration dialog box 72 is displayed in connection with the ‘Image Registration’ button 71b and is open when the print job creation process is at the image registration step.

The image registration dialog box 72 has a work field 73, which includes an image selection field 74 to receive the user's selection of a storage place (a directory or a folder), in which images are stored, and display a list of thumbnails and file names of images stored in the selected storage place and a registered image display field 75 to display a list of thumbnails and file names of registered images. The work field 73 also has a ‘Register’ button 76 to register an image selected in the image selection field 74 and display the registered image in the registered image display field 75 and an ‘All Register’ button 77 to register all the images displayed in the image selection field 74 and display all the registered images in the registered image display field 75. The user selects a desired image storage place in a storage place display field 74a of the image selection field 74, selects a desired image among images displayed in an image display field 74b of the image selection field 74 in response to selection of the storage place (that is, among images stored in the selected storage place), and clicks the ‘Register’ button 76. The desired image is accordingly registered and displayed in an image display field 75a of the registered image display field 75. The registered image display field 75 also has a ‘Registration Cancel’ button 75b to cancel registration of an image selected in the image display field 75a and an ‘All Registration Cancel’ button 75c to cancel registration of all registered images. The image registration dialog box 72 also has a Next’ button 72a to terminate the image registration step and to go to a next step in the print job creation process and a ‘Back’ button 72b to go back to a previous step in the print job creation process. A click of the ‘Back’ button 72b in the image registration window 70 terminates the image registration step and reopens the menu window 60. The ‘Back’ button 72b accordingly has the same function as that of the ‘Back to Menu’ button 71f. The image registration management module 22 of the print job creation apparatus 20 manages this image registration step.

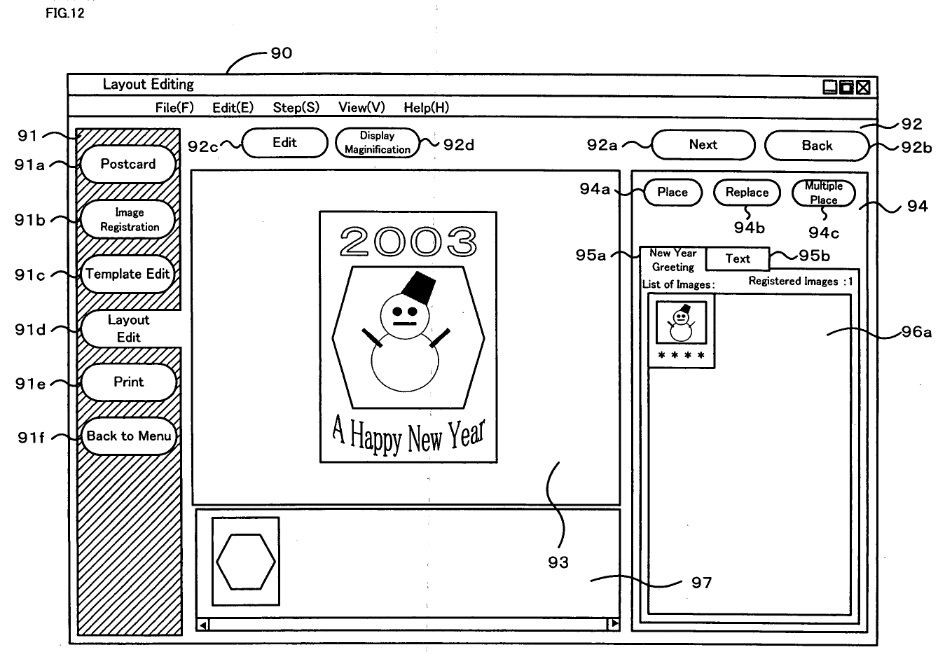

In response to a click of the ‘Next’ button 72a after registration of one or multiple desired images, the print job creation routine opens a template selection window 80 shown in FIG. 11 and executes a template selection step to select a desired template, in which the registered image is inserted (step S120). In the illustrated example of FIG. 11, the template selection window 80 includes a process display field 81, which is identical with the process display field 71 of the image registration window 70 shown in FIG. 10, and a template selection dialog box 82 to select a desired template. In this template selection window 80, the template selection dialog box 82 is displayed in connection with a ‘Template Selection’ button 81c in the process display field 81 and is open when the print job creation process is at the template selection step.

The template selection dialog box 82 has a setting field 83 to specify settings of a template and a template selection field 84 to select a desired template. The setting field 83 includes a layout input box for direct entry of a layout used as a template, a checkbox to set rimless printing, and a checkbox to effectuate image matching of a digital camera with a printer using ‘Print Image Matching 2’ and ‘Exif Print’. The template selection field 84 has tags 85a through 85f corresponding to available template types. The respective tags 85a through 85f have template display fields 86a through 86f to display a list of thumbnails and file names of available templates. The user selects a desired tag among the tags 85a through 85f and selects a desired template among templates displayed in the template display field of the selected tag. In response to selection of the desired template, the selected file name is shown in the layout input box of the setting field 83. The template selection field 84 also has a paper size input box to select a desired paper size. The template selection dialog box 82 has a ‘Next’ button 82a to go to a next step and a ‘Back’ button 82b to go back to a previous step, like the image registration dialog box 72. A click of the ‘Back’ button 82b in the template selection window 80 reopens the image registration window 70, and the processing goes back to the previous step, that is, the image registration step (step S110) in the print job creation process. The template setting management module 23 of the print job creation apparatus 20 manages this template selection step.

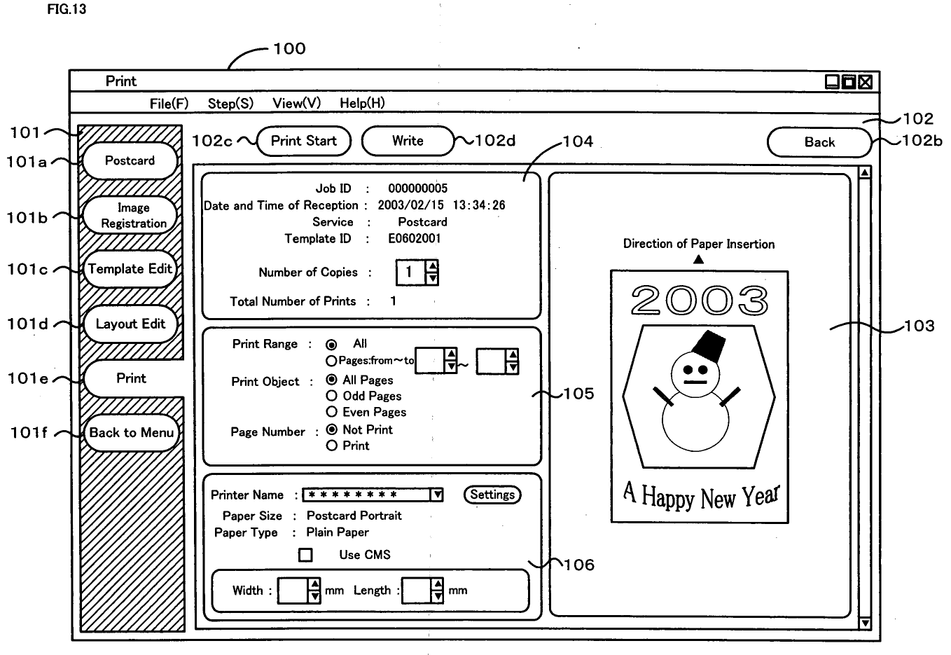

In response to a click of the ‘Next’ button 82a after selection of the desired template, the print job creation routine opens a layout editing window 90 shown in FIG. 12 and executes a layout editing step to adjust a layout of images and edit the images (step S130). In the illustrated example of FIG. 6, the layout editing window 90 includes a process display field 91, which is identical with the process display fields 71 and 81 in the image registration window 70 of FIG. 10 and in the template selection window 80 of FIG. 11, and a layout editing dialog box 92 to layout and edit the images. In this layout editing window 90, the layout editing dialog box 92 is displayed in connection with a ‘Layout Edit’ button 91d in the process display field 91 and is open when the print job creation process is at the layout editing step.

The layout editing dialog box 92 includes a layout editing field 93 to combine the selected template with a registered image and thereby layout and edit the image, an image selection field 94 to select an image to be combined with the selected template, and a thumbnail display field 97 to display the thumbnail of the selected template. The image selection field 94 has a tag 95a for selecting a registered image and a tag 95b for writing a text. The tag 95a has an image display field 96a to display a list of registered images and their file names. The tag 95b has a text input box for entry of a desired text, although not being specifically illustrated. The image selection field 94 also has a ‘Place’ button 94a to place a selected image in the template displayed in the layout editing field 93, a ‘Replace’ button 94b to replace the selected image with an image currently placed in the template in the layout editing field 93, and a ‘Multiple Place’ button 94c to place the selected image in multiple areas of the template. The user may select a desired image among the images displayed in the image display field 96a of the tag 95a and click the ‘Place’ button 94a. This places the selected image in a specified area of the template. The user may select a desired image among the images displayed in the image display field 96a of the tag 95a and click the ‘Replace’ button 94b, while an image has already been placed in a specified area of the template in the layout editing field 93. This replaces the newly selected image with the current image in the specified area of the template. The user may select a desired image among the images displayed in the image display field 96a of the tag 95a and click the ‘Multiple Place’ button 94c. This places the selected image in multiple specified areas of the template. The layout editing dialog box 92 has a ‘Next’ button 92a to go to a next step and a ‘Back’ button 92b to go back to a previous step, like the image registration window 70 and the template selection window 80. The layout editing dialog box 92 also has an ‘Edit’ button 92c to edit the image combined with the template displayed in the layout editing field 93 and a ‘Display Magnification’ button 92d to change a display magnification in the layout editing field 93. When the user selects the image combined with the template displayed in the layout editing field 93 and clicks the ‘Edit’ button 92c, a pulldown menu is open to select a desired specification of editing among various options including rotation, frame rotation, vertical or horizontal inversion, trimming, die cutting, contour softening/sharpening, settings of lightness and contrast, color change, change to sepia/monochromatic, cross filter, red eye reduction, cloning, and auto correction. The output editing management module 24 of the print job creation apparatus 20 manages this layout editing step.

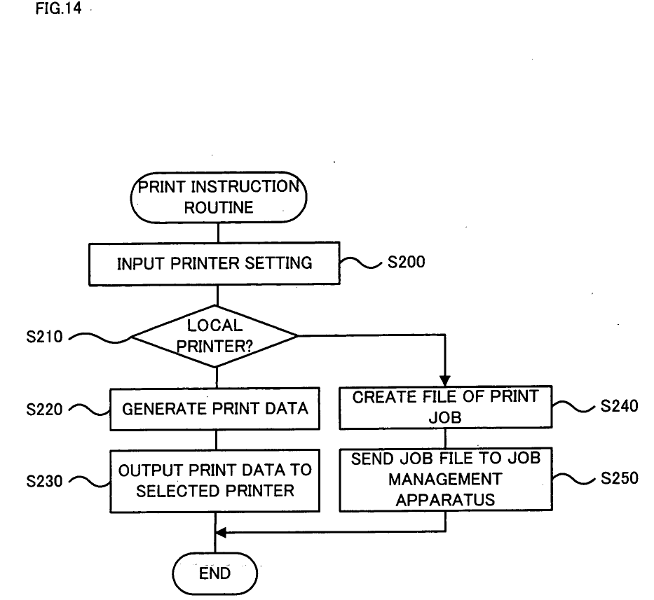

In response to a click of the ‘Next’ button 92a after layout of the image in the selected template and desired editing in the layout editing window 90, the print job creation routine opens a print window 100 shown in FIG. 13 and executes a print step to specify various settings for printing and execute printing (step S140). In the illustrated example of FIG. 13, the print window 100 includes a process display field 101, which is identical with the process display fields 71, 81, and 91 of the image registration window 70, the template selection window 80, and the layout editing window 90, and a print dialog box 102 to specify settings for printing and give a print execution instruction. In this print window 100, the print dialog box 102 is displayed in connection with a ‘Print’ button 101e in the process display field 101 and is open when the print job creation process is at the print step.

The print dialog box 102 has a printed image display field 103 to display a resulting image to be printed, which has been set in the template and gone through layout and editing, a job information display field 104 to display information regarding the print job, a printing condition setting field 105 to set printing conditions, and a printer setting field 106 to specify settings of the printer. The job information display field 104 shows the job ID, the date and time of reception, the service, and the template ID as information regarding the print job, and has a copy number input box to selectively enter a desired number of copies. The printing condition setting field 105 has radio buttons and an input box for setting a print range, radio buttons for setting a print object, and radio buttons for selecting either printing or non-printing of page numbers. The printer setting field 106 has a printer selection box to select a printer to be used for printing, a check box to select either application or non-application of color management system (CMS), and an area input box for setting a printing area. The printer setting field 106 also shows the settings of the paper size and the paper type in the selected printer. The printer selection box in the printer setting field 106 shows the default printer set for the selected combination of the print service and the paper size in the printer settings window 66 of FIG. 6 in the environment settings process. As the printer selected for execution of the print job, the default printer may be replaced by a printer selected among printer options displayed in a pulldown menu of the printer selection box in the printer setting field 106. The paper type displayed here is the paper type set for the selected combination of the print service and the paper size in the printer settings window 66 of FIG. 6 in the environment settings process. The print dialog box 102 also has a ‘Back’ button 102b to go back to a previous step, a ‘Print Start’ button 102c to give a print execution instruction, and a ‘Write’ button 102d to write a resulting image file into a desired directory or folder, instead of printing. The print job creation process executed by the print job creation apparatus 20 of the embodiment terminates in response to a click of the ‘Print Start’ button 102c or in response to a click of the ‘Write’ button 102d. The click of the ‘Print Start’ button 102c or the ‘Write’ button 102d starts execution of the created print job. The print job creation routine of FIG. 9 terminates at this stage. The print management module 25 of the print job creation apparatus 20 of the embodiment manages this print step.

The following describes a series of processing executed, in response to a click of the ‘Print Start’ button 102c in the print window 100. FIG. 14 is a flowchart showing a print instruction routine executed by the print job creation apparatus 20 in response to a click of the ‘Print Start’ button 102c. The print instruction routine first inputs the setting of the printer (printer setting) selected for execution of the print job (step S200), and determines whether the selected printer is the local printer connected via the local network 14, based on the input printer setting (the inkjet printer 46) (step S210). As discussed previously with reference to the printer settings window 66 of FIG. 6, the procedure of the embodiment sets the name of the printer driver installed in the print job creation apparatus 20 as the printer setting, when the printer is the local printer. When the printer is not the local printer, on the other hand, the procedure sets the apparatus ID of the print job creation apparatus 20 connected to another local network 15 and the printer ID of the selected printer as the printer setting.

When the printer setting represents the local printer (the inkjet printer 46), the print instruction routine activates the printer driver of the local printer to generate print data (step S220) and outputs the generated print data to the local printer (step S230). The local printer (the inkjet printer 46) executes printing, based on the output print data.

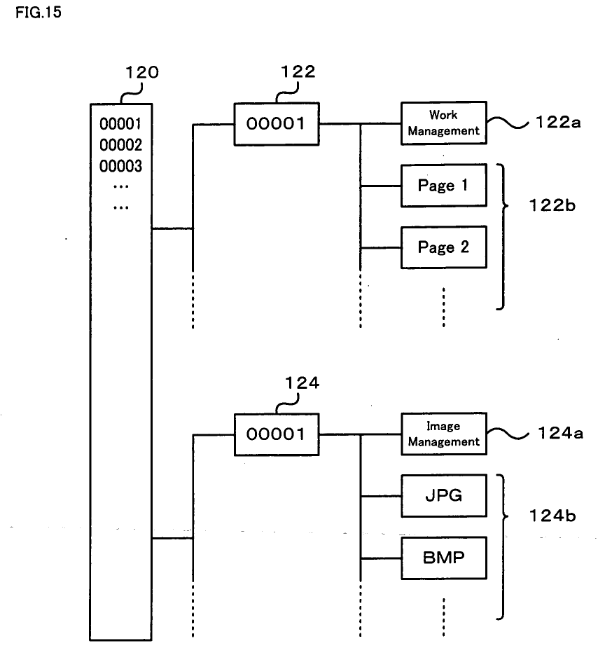

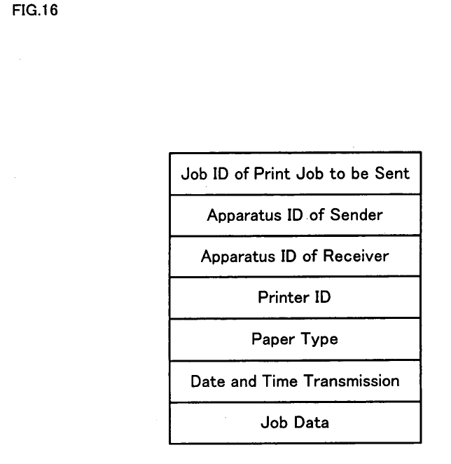

When the printer setting does not represent the local printer (the inkjet printer 46), on the other hand, the print instruction routine creates a file of the print job (step S240) and sends the created job file to the job management apparatus 40 (step S250). FIG. 15 shows an example of management of print jobs. In response to selection of a desired print service, the management process allocates a job ID to each print job, registers the print job with the job ID in a job management file 120, and creates a management field 122. An image registration field 124 is provided on registration of a desired image in the image registration window 70. The management field 122 has a work management field 122a to store the job status representing the step in the print job creation process and the file names of respective pages included in the print job under creation and a page storage field 122b to store the respective pages. The page storage field 122b is provided on selection of a desired template, when the concept of pages arises. The image registration field 124 has an image management field 124a to store the file names and the file formats of the respective images and an image storage field 124b to store images classified in file formats. In the print job creation apparatus 20 of the embodiment, the concept of pages does not arise until selection of the template. The page storage field 122b of the management field 122 is thus generated in response to selection of the template, that is, when the print job creation process goes to the layout editing step. The processing of step S240 in the print instruction routine of this embodiment creates a job file including the contents of the work management field 122a and the page storage field 122b. FIG. 16 shows the data structure of a job file as an example. In this example, the job file includes a job ID allocated to a print job to be sent, which is set by the print job creation apparatus 20 at the time of transmission to the job management apparatus 40, an apparatus ID of the print job creation apparatus 20 as a sender, an apparatus ID of the print job creation apparatus 20 as a receiver, an ID allocated to a printer selected for execution of the print job (printer ID), the paper type, the date and time of transmission, and job data including image data of the respective pages and settings for printing.

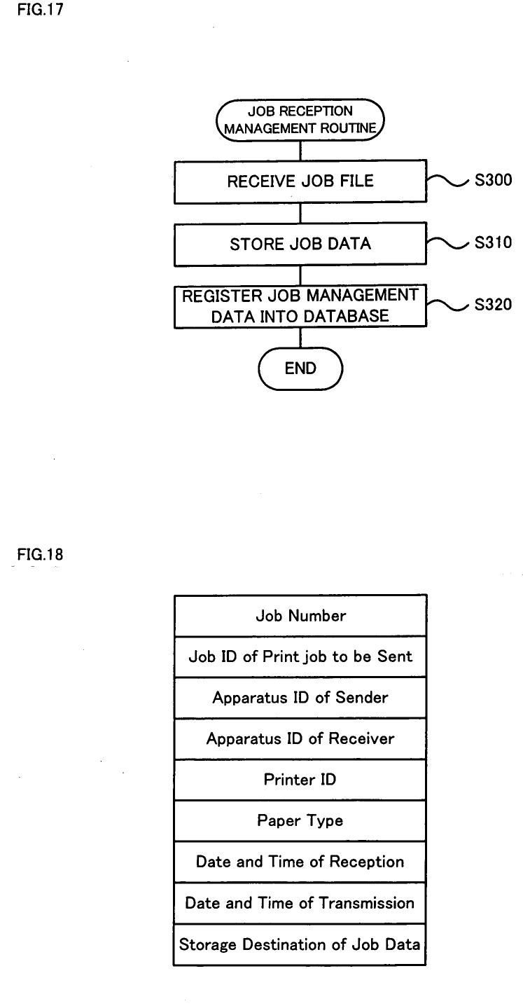

FIG. 17 is a flowchart showing a job reception management routine, which is executed by the job management apparatus 40 when the job management apparatus receives a job file sent from the print job creation apparatus 20. In the job reception management routine, the job management apparatus 40 receives a job file sent from the print job creation apparatus 20 (step S300), stores the job data included in the received job file into a non-illustrated storage device, such as a hard disk (step S310), and registers job management data for management of the job file into the job management database 44 (step S620). FIG. 18 shows the data structure of the job management data registered in the job management database 44 as an example. In this example, the job management data includes a job number allocated to each print job in a registration order, the job ID allocated to the print job to be sent, the apparatus ID of the print job creation apparatus 20 as the sender, the apparatus ID of the print job creation apparatus 20 as the receiver, the ID allocated to the printer selected for execution of the print job (printer ID), the paper type, the date and time of reception of the job file, the date and time of transmission of the job file to the print job creation apparatus 20 as the receiver, and the storage destination of the job data. The respective data other than the ‘date and time of transmission’ are registered at step S610 in the job reception management routine. The ‘date and time of transmission’ is registered when the job file is sent to the print job creation apparatus 20 as the receiver.

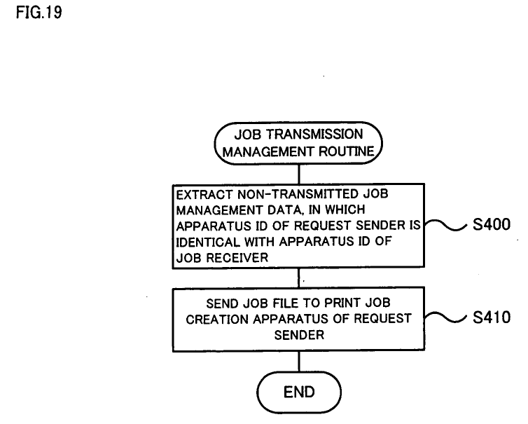

When the print job creation apparatus 20 connecting with the local network 15 outputs a transmission request of a job file, the print job registered in the job management database 44 of the job management apparatus 40 is sent in the form of the job file to the print job creation apparatus 20 of the request sender. FIG. 19 is a flowchart showing a job transmission management routine, which is executed by the job management apparatus 40 when the print job creation apparatus 20 gives a transmission request of a job file. When the job transmission management routine starts, the job management apparatus 40 first extracts non-transmitted job management data, in which the apparatus ID of the print job creation apparatus 20 as the request sender is identical with the apparatus ID of the print job creation apparatus 20 as the job receiver, from the job management database 44 (step S400). The job management apparatus 40 then reads job data from the storage destination of job data specified in the job management data and sends the job data in the form of a job file to the print job creation apparatus 20 as the request sender (step S410). The date and time of this transmission are registered as the date and time of transmission in the job management data.

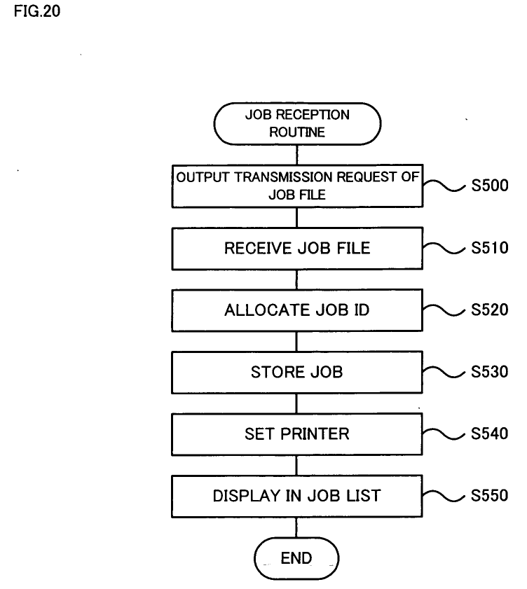

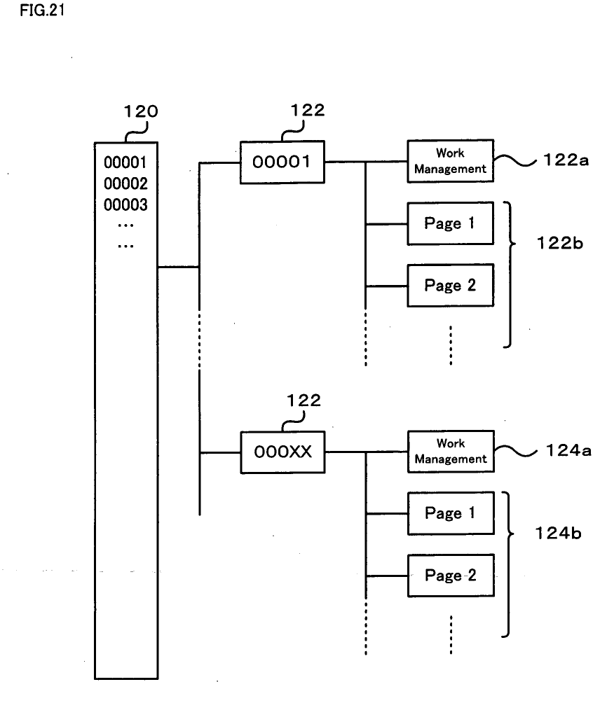

When the job file is sent from the job management apparatus 40, the print job creation apparatus 20 connecting with the local network 15 executes the processing of and after step S510 in a job reception routine shown in FIG. 20. The job reception routine of FIG. 20 also includes a step of outputting a transmission request of a job file to the job management apparatus 40 (step S500). When the job management apparatus 40 sends a job file in response to a transmission request of the job file, the print job creation apparatus 20 receives the transmitted job file (step S510) and allocates a job ID to the job file in an order of reception (step S520). The print job creation apparatus 20 subsequently creates the work management field 122a and page storage field 122b of the management field 122 corresponding to the job file and stores the job file as a print job (step S530). The print job creation apparatus 20 then sets the printer, which is connected with the local network 15 and has the ID identical with the printer ID specified in the print job, to the printer used for printing (step S540), and displays the received print job in the job list field 62 (step S550). FIG. 21 shows an example of management of print jobs when a job file is received. In the illustrated example of FIG. 21, the print job creation apparatus 20 receives a job file, allocates a job ID ‘000XX’ to the received job file, creates the management field 122 including the work management field 122a and the page storage field 122b corresponding to this job ID ‘000XX’, converts the received job file into a print job, and stores the converted print job. As described previously, the contents of the work management field 122a and the page storage field 122b are converted into a job file. The job reception routine thus creates only the portion belonging to the management field 122, while not creating the portion belonging to the image registration field 124. The print job has the display ‘Execution Instructed’ in the status column and ‘Shop A’ in the comment column in the job list field 62 on the menu window 60. The user can thus identify the received print job and understand the requirement for delivery of a resulting print by execution of the print job to the shop A.

The print job creation apparatus 20 receiving the transmitted job file opens the print window 100 shown in FIG. 13, in response to selection of a print job among the print jobs displayed in the job list field 62 on the menu window 60. The print job creation apparatus 20 then gives a print execution instruction of the selected print job by the specified printer according to the print instruction routine of FIG. 14, in response to a click of the ‘Print Start’ button 102c on the print window 100. The print job created by the print job creation apparatus 20 at the shop A is accordingly executed by the printer located at the shop B.

In one example, the print job creation apparatus 20 at the shop A sets the large-scale printer 48 at the shop B as the default printer for printing the enlarged size A1 on the printer settings window 66 of FIG. 6 and creates a print job including selection of enlargement as the print service. The user clicks the ‘Print Start’ button 102c on the print window 100 of FIG. 13, while the printer setting is default. The settings of the default printer selected for enlargement to the size A1 include the apparatus ID of the print job creation apparatus 20 at the shop B, in which the printer driver of the large-scale printer 48 is installed, and the printer ID of the large-scale printer 48. In response to a click of the ‘Print Start’ button 102c, this print job is sent as a job file including the apparatus ID of the print job creation apparatus 20 at the shop B and the printer ID of the large-scale printer 48 to the job management apparatus 40 and is registered in the job management database 44. When the print job creation apparatus 20 at the shop B gives a transmission request of the job file to the job management apparatus 40, the job management apparatus 40 sends the job file including the apparatus ID of the print job creation apparatus 20 at the shop B and the printer ID of the large-scale printer 48 to the print job creation apparatus 20 at the shop B. The print job creation apparatus 20 at the shop B stores the received print job, sets the large-scale printer 48 to the printer used for execution of the print job based on the printer ID of the large-scale printer 48, and displays ‘Execution Instructed’ in the status column and ‘Shop A’ in the comment column in the job list field 62. In response to selection of this print job by the print job creation apparatus 20 at the shop B and a click of the ‘Print Start’ button 102c on the print window 100, the large-scale printer 48 executes the print job.

The print job creation apparatus 20 of the embodiment is allowed to interrupt creation of a print job in the middle of its creation and to resume interrupted creation of the print job. Interruption of creation of a print job is effectuated by the job interruption module 26, in response to a click of any of the ‘Back to Menu’ buttons 71f, 81f, 91f, and 101f in the image registration window 70, the template selection window 80, the layout editing window 90, and the print window 100. The print job under creation is stored in the management field 122 (the work management field 122a and the page storage field 122b) and in the image registration field 124 (see FIG. 15). A list of print jobs under creation is displayed in the job list field 62 on the menu window 60. The display in the status column of the job list field 62 is ‘Before Editing’ when the ‘Back to Menu’ button 71f or 81f is clicked at the stage prior to selection of the template, while being ‘Under Editing’ when the ‘Back to Menu’ button 91f or 101f is clicked after selection of the template. The display of the status informs the user of the current stage of the print job under creation, that is, the stage before selection of the template or the stage after selection of the template. The interrupted creation of a print job is resumed by the job resumption module 27, in response to selection of the print job in the job list field 62. The resumption procedure reads the current status of the print job under creation from the corresponding work management field 122a based on the job ID, opens a processing window corresponding to the current status of the print job, and reproduces the print job under creation with the respective pages stored in the corresponding page storage field 122b. Neither the interruption of creation of a print job nor the resumption of interrupted creation is the essential characteristic of the invention. No further description is thus given here.

The print job creation apparatus 20 of the embodiment is allowed to select a default printer used for execution of a print job among the local printers connecting with another local network different from the local network, to which the print job creation apparatus 20 itself is connected, as well as the local printers connecting with the local network, to which the print job creation apparatus 20 itself is connected. Each print job is thus readily executable by a printer connecting with the different local network. The default printer is set for each combination of the print service and the paper size. This technique does not require setting of a printer every time each print job is executed. The print job is thus readily executable by the printer suitable for the print job. The print job creation apparatus 20 of the embodiment sets the default printer in a tabular form. This arrangement ensures easy setting of the default printer for each combination of the print service and the paper size. The print job creation apparatus 20 of the embodiment is also allowed to set the desired paper type for each combination of the print service and the paper size.

The job management apparatus 40 of the embodiment receives a job file sent from the print job creation apparatus 20 and registers the received job file in the job management database 44. In response to a transmission request from the print job creation apparatus 20 specified as a job receiver, the registered job file is sent to the print job creation apparatus 20 of the request sender. This arrangement ensures transmission of the job file to the print job creation apparatus 20 specified as the job receiver, regardless of the current status of the print job creation apparatus 20 of the job receiver, thus effectively managing transmission of job files between multiple print job creation apparatuses 20.

The print job management system 10 including the print job creation apparatus 20 and the job management apparatus 40 of the embodiment ensures efficient execution of print jobs by the multiple print job creation apparatuses 20 connecting with the different local networks 14 and 15.

The service setting management module 21, the image registration management module 22, the template setting management module 23, the layout editing management module 24, and the print management module 25 included in the print job creation apparatus 20 of the embodiment correspond to the print job creation module of the invention. The printer setting management module 30 corresponds to the default device setting module. The print management module 25 that executes the print instruction routine of FIG. 14 in response to a click of the ‘Print Start’ button 102c on the print window 100 corresponds to the job execution instruction module.

The print job creation apparatus 20 of the embodiment sends a print job in the form of a job file to the job management apparatus 40 in response to a click of the ‘Print Start’ button 102c on the print window 100, when the default printer set for the print job is connected to a different network. The job management apparatus 40 sends the job file in response to a transmission request of the job file from the print job creation apparatus 20 specified as the job receiver. The job management apparatus 40 may, however, be omitted from the system configuration. In such cases, the job file is directly sent from the print job creation apparatus 20 of the job sender to the print job creation apparatus 20 specified as the job receiver.

The print job creation apparatus 20 of the embodiment sets the default printer and the paper type for each combination of the print service and the paper size. One possible modification may set only the default printer for each combination of the print service and the paper size, while not setting the paper type. The default printer may be set, regardless of the print service, for only each paper size, instead of each combination of the print service and the paper size.

The print job creation apparatus 20 of the embodiment sets the default printer and the paper type for each combination of the print service and the paper size in a tabular form. This is, however, not restrictive at all, and any format other than the tabular form may be adopted to set the default printer and the paper type for each combination of the print service and the paper size.

The print job creation apparatus 20 of the embodiment enables the user to select a desired print service among the various options, enlargement, digest printing, calendar printing, idea printing, postcard, photo name card, ID photo, index printing, seal printing, and label printing, on the menu window 60. These options of print services are only illustrative and not restrictive in any sense. Part of these print service options may be specified as selectable, or any print service options different from these options may be specified as selectable. These options may otherwise be combined with other print service options.

The print job creation apparatus 20 of the embodiment provides the album services and the CD writing services, in addition to the print services. The album services or the CD writing services may be omitted, when not required. The CD writing services may be replaced by writing services into other storage media, for example, flexible disks, MDs, DVDs, and flash memories.

The print job creation apparatus 20 of the embodiment displays the status, the job ID, the selected service, the time of reception, the time of update, the paper size, the number of copies, the total number of prints, and the comment as the information regarding the print job under creation in the job list field 62. Display of all these pieces of information is only illustrative and is not restrictive in any sense. Part of these pieces of information may be displayed selectively, or any other pieces of information may be displayed instead. The display may otherwise include these pieces of information in combination with other pieces of information.

In the print job creation apparatus 20 of the embodiment, the print job creation process has the four steps, the image registration step, the template selection step, the layout editing step, and the print step, subsequent to selection of a desired print service. This flow of the print job creation process is not restrictive in any sense and may be modified in various ways.

In the print job creation apparatus 20 of the embodiment, interruption of a print job is allowable at any stage in the print job creation process. Interruption of a print job may, however, be allowed at a preset stage in the print job creation process.

The above description regards the details of the print job creation apparatus 20, the details of the job management apparatus 40, and the details the print job management system 10 including the print job creation apparatus 20 and the job management apparatus 40 as the embodiment of the invention. The technique of the invention may also be actualized by a default printer setting method and a print execution instruction method that utilizes this default printer setting method to create a print job and give a print execution instruction. Other possible applications of the invention include a program that causes the computer to function as the print job creation apparatus 20, a program that causes the computer to attain the default printer setting method, and a program that causes the computer to attain the print execution instruction method. In such applications, the operations of the print job creation apparatus 20 and the operations of the job management apparatus 40 may be specified as steps and programmed in an appropriate programming language.

The above embodiments are to be considered in all aspects as illustrative and not restrictive. There may be many modifications, changes, and alterations without departing from the scope or sprit of the main characteristics of the present invention. All changes within the meaning and range of equivalency of the claims are therefore intended to be embraced therein.

What is claimed is:

1. A print job creation apparatus that creates a print job and gives an instruction of executing the created print job, said print job creation apparatus comprising:
a print job creation module that creates a print job according to a predetermined process of multiple steps, which include a step of setting printing conditions including a paper size;
a default device setting module that selects a printing device for execution of a print job among multiple printing devices connected via a network and setting the selected printing device to a default printing device for each paper size specified in a print job; and
a job execution instruction module that receives an execution request of a selected print job, and gives a print job execution instruction to cause the default printing device set by said default device setting module to execute the selected print job, based on a paper size specified in the selected print job.

2. A print job creation apparatus in accordance with claim 1, wherein said default device setting module sets a printing device connecting with the local network, to which said print job creation apparatus is connected, as the default printing device.

3. A print job creation apparatus in accordance with claim 1, wherein said default device setting module specifies a printer driver of a printing device to set the default printing device.

4. A print job creation apparatus in accordance with claim 1, wherein said default device setting module sets the default printing device for each paper size in a tabular form.

5. A print job creation apparatus in accordance with claim 1, wherein said default device setting module selects the default printing device for each paper size out of a list of printing device options for the paper size.

6. A print job creation apparatus in accordance with claim 1, wherein said default device setting module specifies a paper type, which is used in the default printing device set for each paper size.

7. A print job creation apparatus in accordance with claim 1, said print job creation apparatus further comprising:
a job transmission module that sends a print job to another print job creation apparatus connected to the network; and
a job fetch module that fetches a print job via the network.

8. A print job creation apparatus in accordance with claim 1, wherein said print job creation module selects one print service among multiple print services to create the print job, and
said default device setting module sets a default printing device for each print service.

9. A print job creation apparatus in accordance with claim 8, wherein the multiple print services include at least one of an enlargement printing service, a digest printing service, a calendar printing service, a postcard printing service, a photo name card printing service, an ID photograph printing service, a seal printing service, a label printing service, and an album printing service.

10. A print job creation apparatus in accordance with claim 1, said print job creation apparatus further comprising:
an execution device setting module that specifies a printing device for execution of a print job,
wherein said job execution instruction module gives the print job execution instruction, when said execution device setting module specifies a printing device for execution of a selected print job, to cause the specified printing device to execute the selected print job, and when said execution device setting module does not specify any printing device for execution of the selected print job, gives the print job execution instruction to cause the default printing device set by said default device setting module to execute the selected print job.

11. A print job creation apparatus in accordance with claim 10, wherein said execution device setting module sets a printing device, which is set corresponding to a paper size specified in the selected print job by said default device setting module, to a default and changes the setting of the default to specify a printing device for execution of the print job.

12. A print job creation apparatus that creates a print job and gives an instruction of executing the created print job, said print job creation apparatus comprising:
a print job creation module that creates a print job according to a predetermined process of multiple steps, which include a step of setting printing conditions including a paper size;
a default device setting module that selects a printing device used for execution of a print job, among multiple printing devices including at least one first local printing device connected via a first local network and at least one second local printing device connected via a second local network, which is linked with the first local network via a global network, and sets the selected printing device to a default printing device for each paper size specified in a print job; and
a job execution instruction module that receives an execution request of a selected print job, and gives a print job execution instruction to cause the default printing device set by said default device setting module to execute the selected print job, based on a paper size specified in the selected print job.

13. A print job creation apparatus in accordance with claim 12, wherein a print execution instruction device, which gives a print job execution instruction to the second local printing device, is connected to the second local network, and
said job execution instruction module outputs the selected print job, which is to be transmitted to said print execution instruction device, when the second local printing device is set to the default printing device for execution of the selected print job by said default device setting module.

14. A print job creation apparatus in accordance with claim 13, wherein said job execution instruction module outputs execution request information regarding the execution request of the selected print job, together with the selected print job, which is to be transmitted to said print execution instruction device.

15. A print job creation apparatus in accordance with claim 13, wherein said job execution instruction module sends the selected print job, which is to be transmitted to said print execution instruction device, to a print management server that is connected with the global network and is capable of delivering the selected print job to said print execution instruction device.

16. A print job creation apparatus in accordance with claim 13, wherein said default device setting module uses execution-related information regarding execution of a print job by the first local printing device when the first local printing device is set to the default printing device, while using apparatus-related information regarding the second local printing device and said print execution instruction device when the second local printing device is set to the default printing device.

17. A print job creation apparatus in accordance with claim 16, wherein said default device setting module uses a printer driver of the first local printing device as the execution-related information, when the first local printing device is set to the default printing device.

18. A print job creation apparatus in accordance with claim 12, said print job creation apparatus further comprising:
a job fetch module that fetches a print job via the first local network,
wherein said job execution instruction module gives a print job execution instruction to execute the fetched print job.

19. A print job creation apparatus in accordance with claim 18, wherein said job fetch module fetches the print job via the global network.

20. A print job creation apparatus in accordance with claim 12, wherein said default device setting module sets the default printing device for each paper size in a tabular form.

21. A print job creation apparatus in accordance with claim 12, wherein said default device setting module selects the default printing device for each paper size out of a list of printing device options for the paper size.

22. A print job creation apparatus in accordance with claim 12, wherein said default device setting module specifies a paper type, which is used in the default printing device set for each paper size.

23. A print job creation apparatus in accordance with claim 12, wherein said print job creation module selects one print service among multiple print services to create the print job, and
said default device setting module sets a default printing device for each print service.

24. A print job creation apparatus in accordance with claim 23, wherein the multiple print services include at least one of an enlargement printing service, a digest printing service, a calendar printing service, a postcard printing service, a photo name card printing service, an ID photograph printing service, a seal printing service, a label printing service, and an album printing service.

25. A print job creation apparatus in accordance with claim 12, said print job creation apparatus further comprising:
an execution device setting module that specifies a printing device for execution of a print job,
wherein said job execution instruction module gives the print job execution instruction, when said execution device setting module specifies a printing device for execution of a selected print job, to cause the specified printing device to execute the selected print job, and when said execution device setting module does not specify any printing device for execution of the selected print job, gives the print job execution instruction to cause the default printing device set by said default device setting module to execute the selected print job.

26. A print job creation apparatus in accordance with claim 25, wherein said execution device setting module sets a printing device, which is set corresponding to a paper size specified in the selected print job by said default device setting module, to a default and changes the setting of the default to specify a printing device for execution of the print job.

27. A default device setting method that sets a default printing device, which is used for execution of a print job, in a computer, said default device setting method selecting a printing device for execution of a print job among multiple printing devices connected via a network and setting the selected printing device to a default printing device for each paper size specified in a print job.

28. A default device setting method in accordance with claim 27, said default device setting method setting the default printing device for each paper size in a tabular form.

29. A default device setting method in accordance with claim 27, said default device setting method selecting the default printing device for each paper size out of a list of printing device options for the paper size.

30. A default device setting method in accordance with claim 27, wherein a default printing device is set for each of multiple print services.

31. A default device setting method that sets a default printing device, which is used for execution of a print job, in a computer, said default device setting method selecting a printing device used for execution of a print job, among multiple printing devices including at least one first local printing device connected via a first local network and at least one second local printing device connected via a second local network, which is linked with the first local network via a global network, and sets the selected printing device to a default printing device for each paper size specified in a print job.

32. A default device setting method in accordance with claim 31, a default device setting method setting the default printing device for each paper size in a tabular form.

33. A default device setting method in accordance with claim 31, a default device setting method selecting the default printing device for each paper size out of a list of printing device options for the paper size.

34. A default device setting method in accordance with claim 31, wherein a default printing device is set for each of multiple print services.

35. A print execution instruction method that creates a print job and gives an execution instruction of the created print job, said print execution instruction method comprising the steps of:
(a) selecting a printing device for execution of a print job among multiple printing devices connected via a network and setting the selected printing device to a default printing device for each paper size specified in a print job; and
(b) receiving an execution request of a selected print job, and giving a print job execution instruction to cause the default printing device to execute the selected print job, based on a paper size specified in the selected print job.

36. A print execution instruction method in accordance with claim 35, wherein said step (a) sets a printing device connecting with the local network as the default printing device.

37. A print execution instruction method in accordance with claim 35, wherein said step (a) specifies a printer driver of a printing device to set the default printing device.

38. A print execution instruction method in accordance with claim 35, wherein said step (a) sets the default printing device for each paper size in a tabular form.

39. A print execution instruction method in accordance with claim 35, wherein said step (a) selects the default printing device for each paper size out of a list of printing device options for the paper size.

40. A print execution instruction method in accordance with claim 35, wherein said step (a) specifies a paper type, which is used in the default printing device set for each paper size.

41. A print execution instruction method in accordance with claim 35, said print execution instruction method further comprising the step of:
selecting one print service among multiple print services to create the print job,
wherein said step (a) sets a default printing device for each print service.

42. A print execution instruction method in accordance with claim 41, wherein the multiple print services include at least one of an enlargement printing service, a digest printing service, a calendar printing service, a postcard printing service, a photo name card printing service, an ID photograph printing service, a seal printing service, a label printing service, and an album printing service.

43. A print execution instruction method in accordance with claim 35, said print execution instruction method further comprising the step of
(c) specifying a printing device for execution of a print job, between said step (a) and said step (b),
wherein said step (b) gives the print job execution instruction, when said step (c) specifies a printing device for execution of a selected print job, to cause the specified printing device to execute the selected print job, and when said step (c) does not specify any printing device for execution of the selected print job, gives the print job execution instruction to cause the default printing device set in said step (a) to execute the selected print job.

44. A print execution instruction method in accordance with claim 43, wherein said step (c) sets a printing device, which is set corresponding to a paper size specified in the selected print job in said step (a), to a default and changes the setting of the default to specify a printing device for execution of the print job.

45. A print execution instruction method that creates a print job and gives an execution instruction of the created print job, said print execution instruction method comprising the steps of:
(a) selecting a printing device used for execution of a print job, among multiple printing devices including at least one first local printing device connected via a first local network and at least one second local printing device connected via a second local network, which is linked with the first local network via a global network, and sets the selected printing device to a default printing device for each paper size specified in a print job; and
(b) receiving an execution request of a selected print job, and giving a print job execution instruction to cause the default printing device set in said step (a) to execute the selected print job, based on a paper size specified in the selected print job.

46. A print execution instruction method in accordance with claim 45, wherein a print execution instruction device, which gives a print job execution instruction to the second local printing device, is connected to the second local network, and
said step (b) output the selected print job, which is to be transmitted to said print execution instruction device, when the second local printing device is set to the default printing device for execution of the selected print job in said step (a).

47. A print execution instruction method in accordance with claim 46, wherein said step (b) outputs execution request information regarding the execution request of the selected print job, together with the selected print job, which is to be transmitted to said print execution instruction device.

48. A print execution instruction method in accordance with claim 46, wherein said step (b) sends the selected print job, which is to be transmitted to said print execution instruction device, to a print management server that is connected with the global network and is capable of delivering the selected print job to said print execution instruction device.

49. A print execution instruction method in accordance with claim 46, wherein said step (a) uses execution-related information regarding execution of a print job by the first local printing device when the first local printing device is set to the default printing device, while using apparatus-related information regarding the second local printing device and said print execution instruction device when the second local printing device is set to the default printing device.

50. A print execution instruction method in accordance with claim 49, wherein said step (a) uses a printer driver of the first local printing device as the execution-related information, when the first local printing device is set to the default printing device.

51. A print execution instruction method in accordance with claim 45, said print job creation apparatus further comprising the step of
(c) fetching a print job via the first local network, prior to said step (b),
wherein said step (b) gives a print job execution instruction to execute the fetched print job.

52. A print execution instruction method in accordance with claim 51, wherein said step (c) fetches the print job via the global network.

53. A print execution instruction method in accordance with claim 45, wherein said step (a) sets the default printing device for each paper size in a tabular form.

54. A print execution instruction method in accordance with claim 45, wherein said step (a) selects the default printing device for each paper size out of a list of printing device options for the paper size.

55. A print execution instruction method in accordance with claim 45, wherein said step (a) specifies a paper type, which is used in the default printing device set for each paper size.

56. A print execution instruction method in accordance with claim 45, the print execution instruction method further comprising the step of selecting one print service among multiple print services to create the print job, prior to said step (b),
wherein said step (a) sets a default printing device for each print service.

57. A print execution instruction method in accordance with claim 56, wherein the multiple print services include at least one of an enlargement printing service, a digest printing service, a calendar printing service, a postcard printing service, a photo name card printing service, an ID photograph printing service, a seal printing service, a label printing service, and an album printing service.

58. A print execution instruction method in accordance with claim 45, said print execution instruction method further comprising the step of:
(c) specifying a printing device for execution of a print job, prior to said step (b),
wherein said step (b) gives the print job execution instruction, when said step (c) specifies a printing device for execution of a selected print job, to cause the specified printing device to execute the selected print job, and when said step (c) does not specify any printing device for execution of the selected print job, gives the print job execution instruction to cause the default printing device set in said step (a) to execute the selected print job.

59. A print execution instruction method in accordance with claim 58, wherein said step (c) sets a printing device, which is set corresponding to a paper size specified in the selected print job in said step (a), to a default and changes the setting of the default to specify a printing device for execution of the print job.
